(19) United States
(12) Patent Application Publication
(10) Pub. No.: US 2016/0315657 A1
(43) Pub. Date: Oct. 27, 2016

(54) INTERFERENCE MITIGATION FOR SPECTRUM SHARING

(71) Applicant: Neul Limited, Cambridgeshire (GB)

(72) Inventor: Brian Martin GAFFNEY, Cambridge (GB)

(21) Appl. No.: 15/171,810

(22) Filed: Jun. 2, 2016

Related U.S. Application Data
(63) Continuation of application No. PCT/GB2014/053573, filed on Dec. 2, 2014.

(30) Foreign Application Priority Data
Dec. 2, 2013 (GB) GB1321226.1

(51) Int. Cl. H04B 1/715; H04L 25/03; H04L 5/00

(52) U.S. Cl. CPC H04B 1/715; H04L 5/0007; H04L 25/0384; H04B 2001/7152

(57) ABSTRACT

A communication apparatus for transmitting data in such a way as to minimise interference with a communication, comprising multiple series of data blocks modulating a set of orthogonal frequencies, that is received using a Fourier transform having the length of a data block, the apparatus comprising an alignment unit configured to identify the set of orthogonal frequencies and timings of the data blocks, a pulse train generator configured to generate a pulse train comprising the data, in which the pulses are aligned with the data blocks and a communication unit configured to process the pulse train with a pulse shape and a carrier frequency that are compatible with the identified frequencies and timings of the data blocks to generate a signal that is substantially circulant with respect to the data blocks.

### CROSS-REFERENCE TO RELATED APPLICATIONS

This application is a continuation of International Patent Application No. PCT/GB2014/053573, filed on Dec. 2, 2014, which claims priority to United Kingdom Patent Application No. GB 1321226.1, filed on Dec. 2, 2013, both of which are hereby incorporated by reference in their entireties.

### TECHNICAL FIELD

This invention relates to a communication apparatus for transmitting data in such a way as to minimise the interference caused to another communication. In one example, the other communication may be an OFDM transmission and the communication apparatus may transmit its data in an OFDM guard band.

### BACKGROUND

Orthogonal frequency division multiplexing (OFDM) is a method of encoding digital data onto multiple carrier frequencies. These sub-carriers are chosen to be orthogonal to each other so that cross-talk between them is eliminated. An example of an OFDM transmitter is shown in FIG. 1a. A stream of digital data s(n) is demultiplexed into N parallel data streams that are each mapped to a symbol stream. The parallel symbol streams then undergo an inverse Fourier transform. A cyclic prefix is then added to help with multipath. After being converted to analogue, the resulting time domain samples are mixed onto a carrier frequency and transmitted. The transmitted signal thus comprises the sum of a number of independently modulated orthogonal sub-carriers carried by a main RF carrier.

An example of an OFDM receiver is shown in FIG. 1b. The receiver captures signal r(t), which is mixed down to baseband before being sampled and digitised. The cyclic prefix is removed. The digital signal then undergoes a Fourier transform, converting it back into the frequency domain. This produces N parallel data streams, which are converted back into an estimate of the original stream of digital data s(n) by a symbol detector.

Bandwidth is required to create an ultra-low cost air interface in licensed spectrum for the rapidly emerging Internet-of-Things (IoT) segment. One option would be to make use of the guard bands in some existing OFDM systems. These are empty sub-channels to each side of an OFDM transmission. The challenge is to transmit data close to the OFDM communications without causing an unacceptable level of interference to those communications.

Therefore, there is a need for an improved communication apparatus able to transmit data in such a way that it can minimise interference caused to other communications.

### SUMMARY

According to one embodiment of the invention, there is provided a communication apparatus for transmitting data in such a way as to minimise interference with a communication, comprising multiple series of data blocks modulating a set of orthogonal frequencies, that is received using a Fourier transform having the length of a data block, the apparatus comprising an alignment unit configured to identify the set of orthogonal frequencies and timings of the data blocks, a pulse train generator configured to generate a pulse train comprising the data, in which the pulses are aligned with the data blocks, and a communication unit configured to process the pulse train with a pulse shape and a carrier frequency that are compatible with the identified frequencies and timings of the data blocks to generate a signal that is substantially circulant with respect to the data blocks.

The communication unit may be configured to process the pulse train with a carrier frequency that is orthogonal to the set of orthogonal frequencies.

The communication unit may be configured to process the pulse train with a carrier frequency that is comprised in a guard band associated with the communication.

The communication unit may be configured to process the pulse train with a pulse shape that is circulant with respect to at least one of the data blocks.

The communication unit may be configured to process the pulse train with a pulse shape that is circulant with respect to between one and seventeen data blocks.

The communication unit may be configured to process the pulse train with a pulse shape that is circulant with respect to between three and thirteen data blocks.

The communication unit may be configured to process the pulse train with a pulse shape that comprises one or more balance points positioned at locations having a relatively low gradient relative to the pulse shape as a whole.

The communication unit may be configured to process the pulse train with a pulse shape that is symmetric.

The communication unit may be configured to process the pulse train with a pulse shape that comprises a central peak and a plurality of outer peaks that get progressively smaller in magnitude away from the central peak.

The communication unit may be configured to process the pulse train with a pulse shape in which the rate of decay from one peak to another is sufficiently low for the frequency spectrum of the pulse shape to be contained within the spacing between one frequency and the next in the set of orthogonal frequencies

The communication unit may be being configured to process the pulse train with a pulse shape in which the rate of decay is such that the magnitude of each successive outer peak is, on average, less than half the magnitude of the preceding peak.

The communication unit may be configured to process the pulse train with a pulse shape in which the rate of decay is such that the magnitude of each successive outer peak is less a third of the magnitude of the preceding peak.

The communication unit may be configured to process the pulse train with a pulse shape in which the rate of decay is such that the magnitude of each successive outer peak is less a quarter of the magnitude of the preceding peak.

The apparatus may comprise a selection unit configured to select the compatible pulse shape and carrier frequency from a plurality of pulse shapes and/or carrier frequencies that are available to it.

The selection unit may be configured to select a pulse shape in dependence on the identified timings of the data blocks.

The communication may comprise a cyclic overhead associated with each data block, and the alignment unit may be configured to identify the length of that cyclic overhead.

The selection unit may be configured to select a pulse shape to be the compatible pulse shape in dependence on the identified length of the cyclic overhead.

The communication unit may comprise a convolution unit configured to convolve the generated pulse train with the compatible pulse shape.

The communication unit may comprise a mixer configured to mix the convolved pulse train with the compatible carrier frequency.

The communication apparatus may be configured to generate the signal to be sufficiently circulant for it meet an interference level that is acceptable to the communication.

According to a second embodiment of the invention, there is provided a method for transmitting data in such a way as to minimise interference with a communication, comprising multiple series of data blocks modulating a set of orthogonal frequencies, that is received using a Fourier transform having the length of a data block, the method comprising identifying the set of orthogonal frequencies and timings of the data blocks, generating a pulse train comprising the data, in which the pulses are aligned with the data blocks and processing the pulse train with a pulse shape and a carrier frequency that are compatible with the identified frequencies and timings of the data blocks to generate a signal that is substantially circulant with respect to the data blocks.

The present invention will now be described by way of example with reference to the accompanying drawings.

### BRIEF DESCRIPTION OF DRAWINGS

FIG. 1a shows an example of an OFDM transmitter;

FIG. 1b shows an example of an OFDM receiver;

FIG. 2 shows an example of a communication apparatus;

FIG. 3 shows an example of a communication formed of multiple series of data blocks;

FIG. 4 shows an example of a circulant signal relative to a data block;

FIG. 5a and FIG. 5b show examples of the frequency spectrum of a communication and its guard band;

FIG. 6 shows examples of frequency spectra for different signals; and

FIG. 7 shows an example of a method for transmitting data.

### DESCRIPTION OF EMBODIMENTS

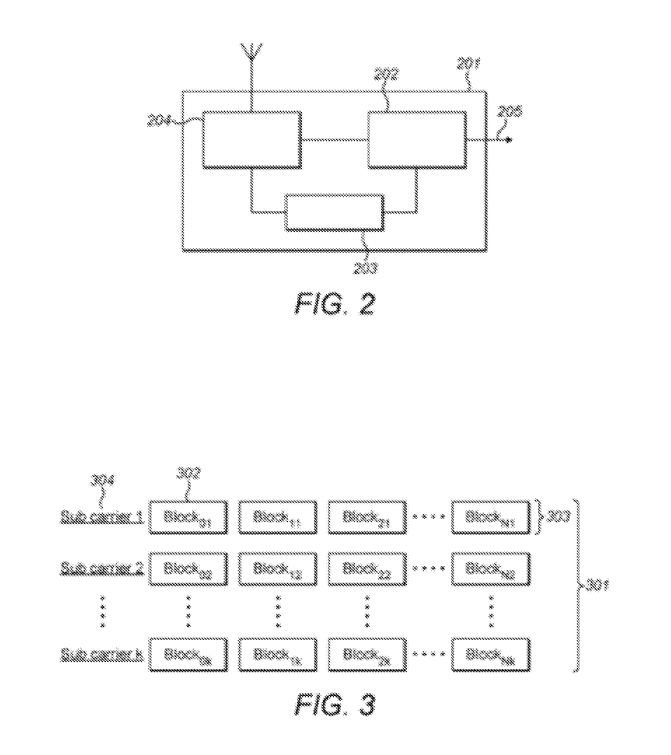

An example of a communication apparatus is shown in FIG. 2. The communication apparatus is shown generally at 201. It is capable of transmitting data in such a way as to minimise interference with a communication transmitted by another network. That communication may comprise multiple series of data blocks transmitted over a set of orthogonal frequencies. In one example the communication is an OFDM transmission. This is just one example and although the description below refers predominantly to an OFDM host system for reasons of convenience it should be understood that the communication apparatus and techniques described herein are not limited to being used with any particular host system. Other suitable host systems include, for example, single carrier frequency division multiple access (SC-FDMA) and single carrier cyclic prefix (SC-CP).

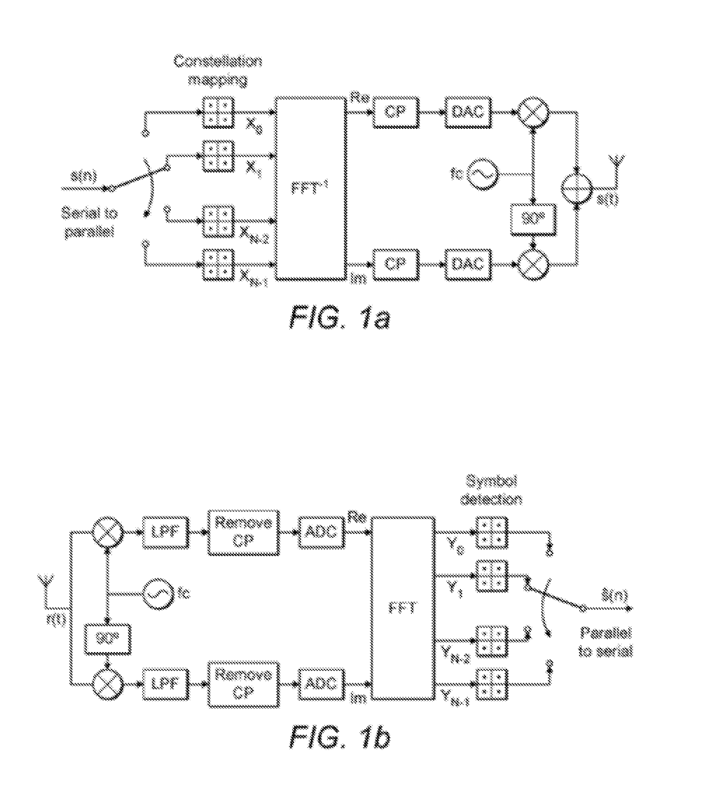

An example of the structure of such a communication is shown in FIG. 3. The communication is shown generally at 301. The data blocks 302 form streams 303 that each modulate a different sub-carrier 304. The communication is the sum of the modulated sub-carriers (which may themselves modulate a main RF carrier). The communication is intended to be received by means of a Fourier transform (see e.g. the receiver shown in FIG. 1b). The receiver is likely to separate the sub-channels by performing frequency equalisation in the frequency domain. The sub-carriers are suitably a set of orthogonal frequencies so that cross-talk between them is eliminated.

The communication apparatus comprises an alignment unit 202 that is configured to identify the set of orthogonal frequencies and the timing of the data blocks. This knowledge of the other communication's timing and frequency may be achieved through a physical connection to the relevant transmitter (indicated at 205 in FIG. 2). Another option would be for the communication apparatus to have a shared clock with the relevant transmitter (e.g. via GPS) and access to a set of rules that govern how the relevant transmitter formats its communications. A further option would be for the communication apparatus to gain knowledge of the other communication through some form of channel sensing. The communication apparatus also comprises a pulse train generator 203 configured to generate a pulse train comprising the data to be transmitted. The pulses in the pulse train are preferably aligned with the data blocks in the other communication. The communication unit also comprises a communication unit 204 that is configured to process the pulse train with a pulse shape and a carrier frequency that are compatible with the identified set of frequencies and the timing of the data blocks. The role of the communication unit is to generate a signal that is substantially circulant with respect to the data blocks.

The communication apparatus in FIG. 2 is shown as comprising a number of functional blocks. This is for illustrative purposes only. It is not intended to define a strict division between different parts of hardware on a chip or between different programs, procedures or functions in software. In some embodiments, some or all of the algorithms described herein may be performed wholly or partly in hardware. In many implementations, at least part of the communication apparatus may be be implemented by a processor acting under software control.

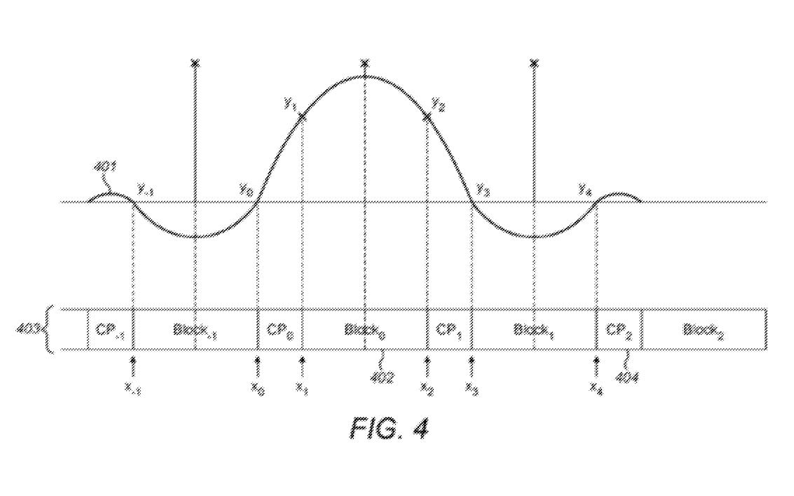

The term “circulant” is used to refer to a signal whose amplitude is the same at the start and end times of the data blocks it is aligned with. An example of a circulant pulse is shown in FIG. 4. The upper half of FIG. 4 shows a pulse 401 that is circulant with respect to the data block 402 of the communication 403 illustrated in the bottom half of the figure. “Balance points” y₁ and y₂ of the pulse are equal in amplitude. It can be seen that pulse 401 is aligned with data block 402 (their midpoints are aligned) and that the two balance points correspond to the start and end times of data block 402. The data blocks in this example also include additional overhead: cyclic prefix 404. The pulse and its balance points are aligned with the data block (and not the data block together with its cyclic prefix) because, in this example, this is the processing window over which the FFT will be performed in the “host” receiver.

As explained above, a communication that is formed by modulating a number of orthogonal sub-carriers may be received by performing a Fourier transform to convert the time domain signal into the frequency domain. The orthogonal sub-carriers do not interfere with each other. One option for transmitting close to such a communication without interfering with it is to transmit on a frequency that is orthogonal to the set of sub-carriers used by the host system. The host receiver would simply discard the sub-carrier that is not of interest to it. The problem is that the “neighbour” transmission will inevitably include other frequency components in addition to its carrier frequency, meaning that the receiver of the other communication will see spectral leakage at the output of its Fourier transform that may interfere with the communication it is trying to receive.

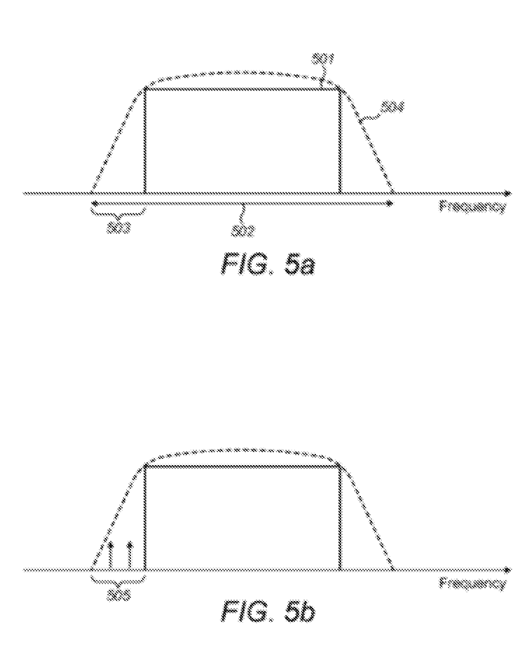

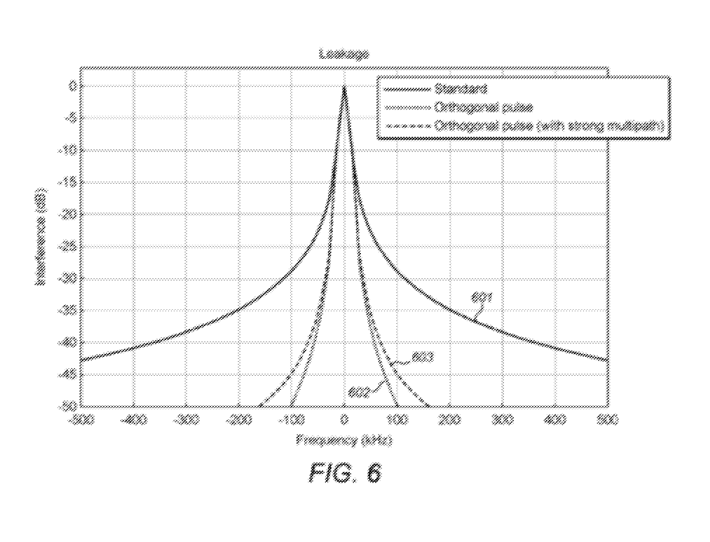

This can be understood with reference to FIGS. 5a and b. FIG. 5a shows an example of the frequency spectrum of an OFDM communication. The frequency spectrum might be generated by an FFT that is 1024 bits long, say (represented by 502). Only the spectrum that is comprised within the central 600 bins of the FFT (represented by 501) are of interest to the receiver, however. The outer bins (represented by 503) are in the host channel's guard-band (represented by dotted line 504). Those bins were zero-padded at the transmitter and will be ignored by the receiver. Another communication system therefore might use the guard band without troubling the OFDM receiver, providing that the other communication system's transmissions approximate delta functions in the frequency domain (see 505 in FIG. 5b). Unfortunately the frequency spectrum of a typical transmission is more likely to have the form shown at 601 in FIG. 6. The spectral leakage can impinge on the central bins of the OFDM receiver's FFT, causing unacceptable interference.

The significance of the start and end times of the data blocks in the OFDM system is that these represent the start and end points of the FFT at the OFDM receiver. If the amplitude of the neighbour transmission is the same at those start and end points, it will comprise a sum of complex sinusoids for the duration of the data block and hence will appear at the output of the receiver's FFT as one or more deltas, or “spikes”. These will simply be ignored by the OFDM receiver when they appear in its guard band. Therefore, if the signal is circulant over the host receiver's FFT processing window, it will cause zero interference outside of its own signal bandwidth.

A real-world example of a suitable host communication system is one that uses the LTE (Long Term Evaluation) protocol. Current LTE specifications define channels that could be 1.4 MHz, 3 MHz, 5 MHz, 10 MHz, 15 MHz or 20 MHz wide. Contained within each channel are a large number of sub-channels, each associated with a carrier frequency that is orthogonal to the other carrier frequencies defined for that channel. The current LTE specifications also specify a guard band to either side of the LTE resource block. For a 10 MHz LTE downlink channel, the bandwidth of the guard bands either side of the resource block is 500 kHz.

The bandwidth available in LTE guard bands could be utilised by a single-carrier communication system. In one example, they may be used to provide bandwidth for IoT communications. The narrow bandwidth that guard bands provide are particularly suitable for IoT communications, which are typically tolerant of delays and low bit rates that would be impractical in most other networks. IoT protocols also tend to be optimised for low power operation since many IoT terminals are small, battery-powered devices. Limited power transmissions may further minimise the risk of interference to the host system, so IoT communications are well suited to this application. These are only examples, however, and any suitable communication systems and protocols might utilise the methods and apparatus described herein.

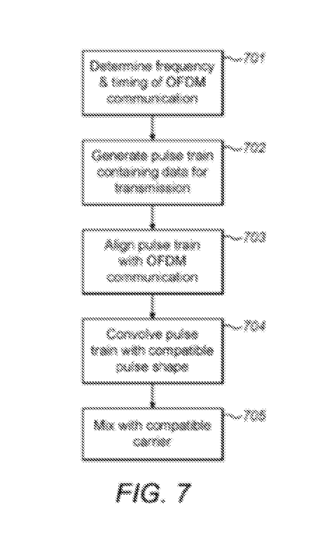

An example of a method for transmitting data is shown in FIG. 7. In step 701, the communication apparatus determines the sub-carrier frequencies and timing of the OFDM host system. In many implementations this will be performed over a wired link between the apparatus and the OFDM base station. The single-carrier transmissions are most likely to cause problematic interference on the OFDM downlink. The single-carrier base station and the OFDM base station are likely to be configured to exchange information so that spectral leakage on the uplink can be addressed by other means.

For example, each uplink single-carrier channel may be individually pulse-shaped so that it is completely separable in frequency. The sub-channels can then be separated at the OFDM base station by filtering techniques, with low susceptibility to frequency errors and mismatched power levels. On the downlink, the terminal receiving the OFDM transmission will have no knowledge of the single-carrier system.

In step 702 the single-carrier system generates a pulse train containing its data. Suitably the pulse rate is chosen to help align the pulse train with the OFDM communication. For example, if the OFDM communication is of the form shown in FIG. 4, the pulse rate is suitably chosen to be:

f_{SC}L/(L+L_{CP}) (1)

where f_{SC} is the OFDM sub-carrier spacing, L is the length of the OFDM block and L_{CP} is the cyclic overhead (which may be a prefix or a postfix). The data in the pulse train can be amplitude or phase modulated using any of the known PSK/QAM schemes, including rotated and differential versions.

The pulse train is then aligned in time with the OFDM block (step 703). For systems with variable cyclic overheads, such as LTE, the necessary timing adjustment can be made in step 703.

The pulse train is convolved with a compatible pulse shape (step 704) and the resulting signal is then mixed with a compatible carrier frequency (step 705). The pulse shape and carrier frequency can be considered “compatible” with the OFDM communication if together they are capable of producing a signal that is substantially circulant with respect to the OFDM communication, given its specific frequency and data block timings. One straightforward way of achieving this is for the carrier frequency to be a valid multiple of one of the OFDM's sub-carriers but outside of the OFDM signal, e.g. one of the orthogonal sub-carriers located in the guard band. An orthogonal carrier will be inherently circulant with respect to the data blocks. If the pulse shape is also “circulant”, then the product of the two will also be circulant. Circulance can also be maintained by careful choice of pulse and mixing frequencies so that the result is circulant. In this case, the carrier frequency need not be orthogonal and the pulse shape need not be circulant, providing that their product has the required properties.

The pulse shape is constructed so that circulance is maintained over the FFT processing windows which it overlaps. A large family of suitable pulse shapes exist. In practice, exact circulance is not required and a pulse shape that is capable of generating a signal that is substantially circulant is all that is needed. An example is shown in FIG. 6, which shows a simulation of the spectral leakage that would be expected of the pulse shown in FIG. 4 at 602. It can be seen that while some spectral leakage has occurred, it is greatly reduced compared with the spectral leakage of the standard pulse 601.

The extent to which deviation from exact circulance is acceptable depends on the ability of the OFDM system to tolerate interference. The interference that is caused to an OFDM sub-carrier at a distance Δf from the interferer by a deviation from exact circulance is approximated by:

$${\sum }_{BLOCKS} {Δ}_{b}^{2} {\int }_{Δ f + \frac{{B}_{w}}{2}}^{Δ f - \frac{{B}_{w}}{2}} {\vert Sin c ( \frac{Δ f}{{f}_{sc}} ) \vert}^{2} \qquad ( 2 )$$

Where B_{W} is the bandwidth of the single-carrier signal, f_{SC} is the sub-carrier spacing, Δ_{b} is the normalised deviation from circulance of the single-carrier signal in respect of block b and BLOCKS is the number of OFDM blocks spanned by the single-carrier pulse. The communication apparatus is preferably configured to generate its signals so that they are sufficiently circulant for the interference caused to the OFDM host system to be within the boundaries of what is acceptable to that system.

One reason why the single-carrier signal may deviate from exact circulance is that it may not be realistic to maintain this property beyond a few blocks of the OFDM signal.

The single pulse in FIG. 4 can be written as p(t), it has the following properties:

p(x₁)=p(x₂)

p(x₋₁)=p(x₀)

p(x₃)=p(x₄)

The pulse covers three blocks in total: one central block and one block on either side of the central block. It has 6 balance points. FIG. 4 does not show the pulse continuing beyond those three blocks but a real-world pulse is likely to continue decaying.

It becomes increasingly difficult to precisely control the amplitude of the pulse further away from its central peak. FIG. 4 shows only one pulse. In reality the pulse train will be a series of many pulses so that, when it is convolved with the pulse shape, the resulting pulses are summed. If the pulse shapes are circulant over the required windows, then the sum is also circulant. In practice, however, the effect of non-circulant outer portions of some pulses will cause the overall pulses to deviate slightly from circulance.

The number of blocks over which the pulse shape has to be circulant will depend on the interference tolerance of the OFDM host system. Preferably the pulse shape is circulant over at least one block (two balance points). For reasons of practicality, the pulse shape is preferably not circulant over more than seventeen blocks (one central block and eight either side, which gives thirty four balance points). Most preferably the pulse shape is circulant over between three and thirteen blocks (that is one central block and one either side, which gives 6 balance points, and one central block and six either side, which gives twenty six balance points, respectively).

One way to limit the impact of any lack of circulance in the outer lobes of the pulse shape would be to use a pulse that decays quickly. A slower decay rate is preferred, however, to minimise higher frequency components in the pulse. This is to prevent integer multiples of sine waves contained within the FFT processing window from intruding into the band of OFDM sub-carriers when a long pulse is truncated for implementation.

Each peak in the pulse away from the central peak is preferably smaller in magnitude than the peak that preceded it. The maximum acceptable rate of decay from one peak to the next is likely to average around a half. Preferably the rate of decay is a third and more preferably it is a quarter.

Aside from reasons of practicality in generating real pulse shapes, there may be reasons to deliberately introduce a deviation from circulance into the pulse shapes. For example, to achieve the right balance in a trade-off between the degree of circulance needed to avoid causing interference to the OFDM system and having a frequency spectrum that minimises interference within the single-carrier system.

In many cases it will be convenient for the pulse shape to be symmetric, but this need not be the case.

If there is multipath, the single-carrier system will no longer be orthogonal to the LTE signal. This can be at least partially addressed by designing a pulse shape to have the extra constraint that the pulse should not change significantly around the balance points. In other words, the balance points should be positioned in parts of the pulse shape that have a relatively low gradient. Doing this reduces the amount of spectral leakage by controlling the deviation from circulance caused by multipath. An example of the effects of multipath is shown at 603 in FIG. 6.

The shape of the pulse is also dependent on qualities of the OFDM signal itself, such as the block length and the length of any cyclic overhead. Some OFDM systems use different block lengths and/or cyclic overheads. LTE is an example. Therefore, the communication apparatus may have multiple pulse shapes available to it, from which it can select the most appropriate pulse shape according to the exact format communication being transmitted by the OFDM system. The communication apparatus might also have pulse shapes available to it that perform particularly well in multipath, and which it can deploy if multipath is an issue.

The methods described herein may be applied to a communication network configured for IoT communication. An example would include a network configured to operate according to the Weightless™ protocol (although the methods described herein may be readily implemented by networks configured to operate according to a different protocol). Typically the network will consist of a number of communication devices (e.g. base stations) that are each configured to communicate with a large number of geographically spaced terminals. The communication apparatus described herein may be implemented by just such a communication device. The network may be a cellular network, with each communication device being responsible for over the air communications with terminals located in a respective cell. The communication devices suitably communicate via a wired or wireless interface with a core network and may act, at least partially, under the core network's control. The communication devices may be also be configured to operate according to the host protocol (e.g. LTE) in addition to the IoT protocol.

In one example, the communication apparatus described herein may be configured to operate in accordance with the Weightless™ IoT specification. Weightless™ uses a cellular WAN architecture, with protocols optimised for the requirements of an IoT system (low terminal cost, low terminal duty cycles and hence low power consumption, and scalability to very low data rates). It was originally designed to operate in TV Whitespace spectrum from 470 to 790 MHz, but the PHY is generalised to operate in licensed, shared licensed access and license-exempt bands of varying bandwidths.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A communication apparatus for transmitting data in such a way as to minimise interference with a communication, comprising multiple series of data blocks modulating a set of orthogonal frequencies, that is received using a Fourier transform having the length of a data block, the apparatus comprising:
an alignment unit configured to identify the set of orthogonal frequencies and timings of the data blocks;
a pulse train generator configured to generate a pulse train comprising the data, in which the pulses are aligned with the data blocks; and
a communication unit configured to process the pulse train with a pulse shape and a carrier frequency that are compatible with the identified frequencies and timings of the data blocks to generate a signal that is substantially circulant with respect to the data blocks.

2. A communication apparatus as claimed in claim 1, the communication unit being configured to process the pulse train with a carrier frequency that is orthogonal to the set of orthogonal frequencies.

3. A communication apparatus as claimed in claim 1, the communication unit being configured to process the pulse train with a carrier frequency that is comprised in a guard band associated with the communication.

4. A communication apparatus as claimed in claim 1, the communication unit being configured to process the pulse train with a pulse shape that is circulant with respect to at least one of the data blocks.

5. A communication apparatus as claimed in claim 1, the communication unit being configured to process the pulse train with a pulse shape that is circulant with respect to between one and seventeen data blocks.

6. A communication apparatus as claimed in claim 1, the communication unit being configured to process the pulse train with a pulse shape that is circulant with respect to between three and thirteen data blocks.

7. A communication apparatus as claimed in claim 1, the communication unit being configured to process the pulse train with a pulse shape that comprises one or more balance points positioned at locations having a relatively low gradient relative to the pulse shape as a whole.

8. A communication apparatus as claimed in claim 1, the communication unit being configured to process the pulse train with a pulse shape that is symmetric.

9. A communication apparatus as claimed in claim 1, the communication unit being configured to process the pulse train with a pulse shape that comprises a central peak and a plurality of outer peaks that get progressively smaller in magnitude away from the central peak.

10. A communication apparatus as claimed in claim 9, the communication unit being configured to process the pulse train with a pulse shape in which the rate of decay from one peak to another is sufficiently low for the frequency spectrum of the pulse shape to be contained within the spacing between one frequency and the next in the set of orthogonal frequencies

11. A communication apparatus as claimed in claim 9, the communication unit being configured to process the pulse train with a pulse shape in which the rate of decay is such that the magnitude of each successive outer peak is, on average, less than half the magnitude of the preceding peak.

12. A communication apparatus as claimed in claim 9, the communication unit being configured to process the pulse train with a pulse shape in which the rate of decay is such that the magnitude of each successive outer peak is less a third of the magnitude of the preceding peak.

13. A communication apparatus as claimed in claim 9, the communication unit being configured to process the pulse train with a pulse shape in which the rate of decay is such that the magnitude of each successive outer peak is less a quarter of the magnitude of the preceding peak.

14. A communication apparatus as claimed in claim 1, comprising a selection unit configured to select the compatible pulse shape and carrier frequency from a plurality of pulse shapes and/or carrier frequencies that are available to it.

15. A communication apparatus as claimed in claim 14, the selection unit being configured to select a pulse shape in dependence on the identified timings of the data blocks.

16. A communication apparatus as claimed in claim 1, wherein the communication comprises a cyclic overhead associated with each data block, and the alignment unit is configured to identify the length of that cyclic overhead.

17. A communication apparatus as claimed in claim 16, the selection unit being configured to select a pulse shape to be the compatible pulse shape in dependence on the identified length of the cyclic overhead.

18. A communication apparatus as claimed in claim 1, the communication unit comprising a convolution unit configured to convolve the generated pulse train with the compatible pulse shape.

19. A communication apparatus as claimed in claim 1, the communication unit comprising a mixer configured to mix the convolved pulse train with the compatible carrier frequency.

20. A communication apparatus as claimed in claim 1, the communication apparatus being configured to generate the signal to be sufficiently circulant for it meet an interference level that is acceptable to the communication.

21. A method for transmitting data in such a way as to minimise interference with a communication, comprising multiple series of data blocks modulating a set of orthogonal frequencies, that is received using a Fourier transform having the length of a data block, the method comprising:
identifying the set of orthogonal frequencies and timings of the data blocks;
generating a pulse train comprising the data, in which the pulses are aligned with the data blocks; and
processing the pulse train with a pulse shape and a carrier frequency that are compatible with the identified frequencies and timings of the data blocks to generate a signal that is substantially circulant with respect to the data blocks.
